(19) United States
(12) Patent Application Publication
(10) Pub. No.: US 2011/0197828 A1
(43) Pub. Date: Aug. 18, 2011

(54) Power Generation Using Water Pressure

(76) Inventor: Zoran Iskrenovic, Nis (RS)

(21) Appl. No.: 13/026,008

(22) Filed: Feb. 11, 2011

Related U.S. Application Data
(60) Provisional application No. 61/304,652, filed on Feb. 15, 2010.

(51) Int. Cl. F22B 33/00; F03G 3/00

(52) U.S. Cl. 122/1 R; 60/639

(57) ABSTRACT

Systems are disclosed that use water pressure to generate power. The systems can include a chamber having an inlet conduit and an outlet conduit that has a valve configured to regulate an outlet flow of water through the outlet conduit. A reciprocating element can be disposed within the chamber, such that the reciprocating element is moved as a function of a pressure of an inlet flow of water flowing through the inlet conduit. A generator can be coupled to the reciprocating element, such that power is generated as a function of the reciprocating element's movement.

This application claims priority to U.S. provisional patent application Ser. No. 61/304,652 filed on Feb. 15, 2010. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is power generation.

### BACKGROUND

Water heaters are often one of the largest uses of energy in a home, and are typically powered by a flow of gas or electricity. Although efforts have been made to reduce the amount of energy required by water heaters, they still require a large amount of energy to operate.

To reduce the energy required by a water heater, WIPO Publ. No. 99/36676 to Guyer (publ. July 1999) discusses a cogeneration system that produces heat and electrical power. The Guyer device has many disadvantages as it (1) requires a large amount of energy to pump the water to a high pressure so that it can be expanded to produce energy; (2) uses steam to heat the water requiring an always “on” system; and (3) requires the use of a separate boiler to create steam that is later used to heat household water.

To extract power from a municipal water line, it has been known to place a turbine within the conduit. However, such experiments have produced only a limited amount of power (e.g., approximately 90 W). For example, it is also known to generate power for a light from water pressure in a shower head such as the ECOlight™ shower light by Sylvania™ (http://www.sylvaniaonlinestore.com/p-54-ecolight-shower-light.aspx). While this can be useful to power a light-emitting diode (LED), the power produced in insufficient for much else, and certainly is insufficient to heat the water that powers the light.

Energy has also been harvested from high pressure waste fluids in filtration systems (e.g., U.S. Pat. No. 6,589,423 to Chancellor, et al.). In such systems, a positive displacement device or turbine device can be used to harness at least some of the energy in the high-pressure fluid for other purposes. However, such systems are disadvantageous because they are often large and complex, and typically require a pressurization system at the front-end which can require a large amount of energy.

Thus, there is still a need for a system that leverages an inlet water pressure to generate power for a water heater or other uses.

### SUMMARY OF THE INVENTION

The inventive subject matter provides apparatus, systems and methods for a power generation system using water pressure. Contemplated systems can include a power generator having an inlet conduit and an outlet conduit. The outlet conduit can have a first valve configured to control water flow through the outlet conduit. The power generator can be configured to generate power at least in part by utilizing the pressure of the water flowing through the inlet conduit. Preferably, the systems minimize any pressure loss of the water exiting the generator, and it is especially preferred, though not required, that the outlet pressure of the outlet water flow is at least 90% of an inlet pressure of the inlet water flow.

In some contemplated embodiments, water from the power generator can be fed into a water heater that is powered at least in part by the power generated from the generator. In this manner, the water used to generate power can advantageously be heated using at least some of the power generated from the water's pressure.

In other contemplated embodiments, the generated power can be, for example, stored in a battery, used to power various electrical devices, and/or transmitted to the local electrical grid for an energy credit.

Preferred power generators include a piston head that oscillates within a chamber. Thus, as water flows into and out from the chamber, the piston head will translate back and forth due to the change in pressure applied to opposite surfaces of the piston head. In especially (preferred embodiments, the piston head has a radius that is at least two times the radius of the inlet conduit, and more preferably at least three times the inlet conduit's radius. This is critical because the surface area of the piston head exponentially increases as the radius of the piston increases.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of an embodiment of a water pressure powered water heater system.

FIG. 2 is a schematic of an embodiment of a power generation system.

FIGS. 3A-3E are various schematics of another embodiment of a power generation system.

FIG. 4 is a schematic of another embodiment of a power generation system.

FIGS. 5 and 6 are schematics of other embodiments of a water pressure powered water heater system.

FIG. 7 is an exploded view of yet another embodiment of a water pressure powered water heater system.

FIG. 8 is a schematic of yet another embodiment of a water pressure powered water heater system.

FIG. 9 is a perspective view of the system of FIG. 7.

### DETAILED DESCRIPTION OF THE INVENTION

The inventive subject matter provides apparatus, systems and methods in which a power generator that transforms water pressure into energy is used to power a water heater.

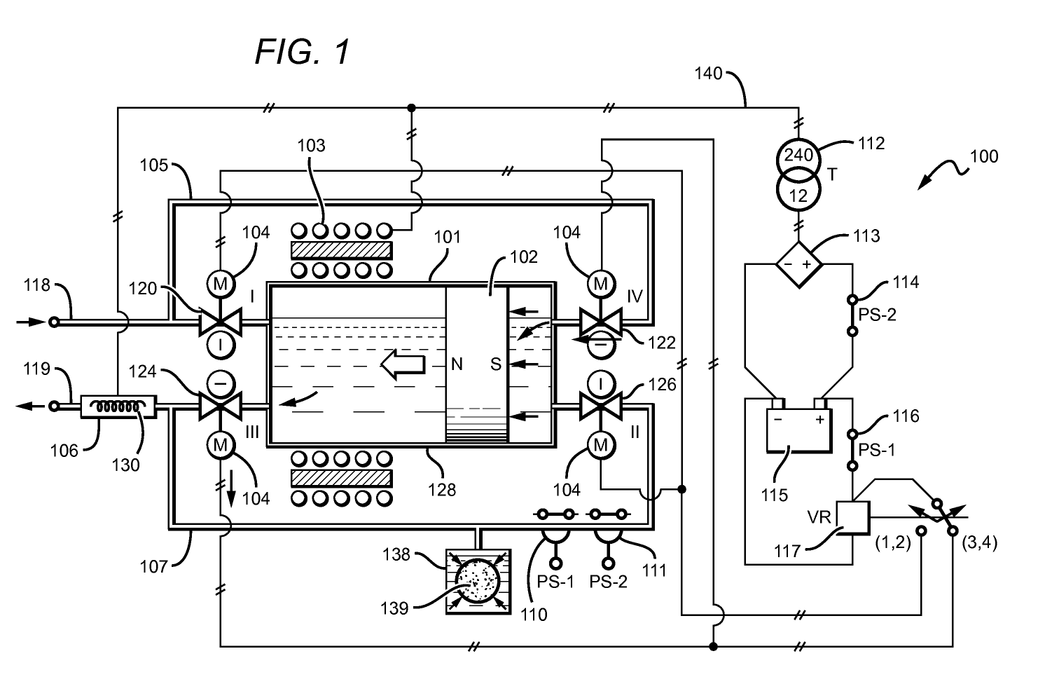

In FIG. 1, a water pressure powered water heater system 100 is shown having a water inlet conduit 118 and a water outlet conduit 107. The water inlet conduit 118 and outlet conduit 107 can be fluidly coupled to a power generator 101 via inlet valves 120 and 122, and outlet valves 124 and 126, which respectively control the flow of water into and out from the power generator 101. Conduit 105 can direct a portion of the water from inlet conduit 118 to valve 122. Although system 100 is shown having four valves, it is contemplated that the number of valves could vary depending on the specific configuration of system 100. For example, two ball valves might be used, each of which could control water into and out from the power generator 101.

The valves 120, 122, 124, and 126 are preferably electrically operated by actuators 104, although mechanically operated valves are also contemplated. Any commercially suitable valves could be used including, for example, needle valves, ball valves, gate valves, poppet valves, plug valves, globe valves, butterfly valves, and diaphragm valves. Contemplated valves can regulate flow in one or more directions using any commercially suitable design including for example, a straight-through, a two-way, and a three-way design.

In some contemplated embodiments, the power generator 101 can comprise a chamber 128 fluidly coupled to the inlet conduit 118 and outlet conduit 107. A piston 102 can be disposed within the chamber 128 such that the piston 102 can oscillate back and forth within the chamber 128. The piston 102 preferably comprises a magnet, a magnetized metal, a metal, a metal composite, or other commercially suitable materials or combination(s) thereof, such that the piston 102 can magnetically interact with one or more electromagnetic coils 103. The coils 103 can advantageously be disposed about at least a portion of the chamber 128, and configured to generate electrical power as a function of the piston's oscillation. The coils 103 can be of between 0.5-50 Teslas, and more preferably, between 3-10 Teslas in strength. It is contemplated that the power generator could produce anywhere between 1-10 kW of power, and more preferably between 2-6 kW of power. However, the actual power generated could vary depending on the size and dimension of the system 100, the inlet water pressure, and other factors.

Oscillation of the piston 102 can be controlled by alternating the flow of water into and out from chamber 128. For example, by using a timer relay 117 and/or other valve controller(s), the opening and closing of the valves 120, 122, 124, and 26 can be precisely controlled. In preferred embodiments, valve 120 and valve 126 can be opened such that water flows into the chamber 128 through valve 120, and out from the chamber 128 through valve 126. The resulting increase in pressure on a first side of piston 102, and a corresponding decrease in pressure on a second side (opposite side) of piston 102, causes the piston 102 to move within chamber 128. Next, valve 120 and 126 can be closed, while valve 122 and 124 are opened. In this manner, water will begin to flow into the chamber through valve 122 and exit the chamber through valve 124. The resulting increase in pressure on the second side, and a decrease in pressure on the first side, causes the piston 102 to move in an opposite direction as before, thereby completing one oscillation. By rapidly opening and closing the valves 120, 122, 124, and 126 in asynchronous or near-synchronous fashion, the oscillation of the piston 102 can be controlled, and power can be generated. Although the rate of the piston's oscillations can vary depending on the application, the piston 102 can be configured to oscillate at a rate of between 5-50 oscillations per second. Such a rate of oscillation is advantageous as it allows for water to flow from the outlet conduit 119 at a near continuous rate and pressure.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

In some contemplated embodiments, the power generator 101 can comprise a turbine that is preferably composed of a metal, metal composite, or combination thereof, such that rotation of the turbine proximal to the coils 103 can produce electrical power.

The coils 103 can be indirectly or directly coupled to a heating device 106 and a battery 115. A circuit 140 can electrically couple the generator 101 and battery 115. The circuit 140 can include an adapter 113 and pressure control switches 114 and 116. The circuit 140 can also include a transformer 112 that can reduce the voltage of the electricity produced by the power generator 101 to a voltage that can be used by the battery 115. For example, the power generator 101 might produce power at a voltage of 240 volts, and the battery might operate at 12 volts. In this manner, the power generated by the power generator 101 can be used to (a) power the water heating device 106, and (b) charge the battery 115, as needed. It is contemplated that the battery 115 could be used to store unused energy produced by the power generator 101, which otherwise would be wasted when hot water is not being used. Alternatively or additionally, the power generated from the power generator 101 can provide power for energy uses other than system 100.

Battery 115 can be used to power the electronics of the system 100 including, for example, valves 120, 122, 124, and 126, timer relay 117 and/or other valve controllers, pressure regulators, sensors, and other electronic component of system 100. The battery 115 can be used to initially power the system 100 until the power generator 101 begins to generate power. However, it is also contemplated that other sources of power could be alternatively or additionally be used for any initial power requirements including, for example, photovoltaic cells and a line voltage. Contemplated batteries include 12-volt batteries, although other voltages and types of batteries could be used.

Water exiting the chamber 128 can flow through outlet conduit 107 and heating device 106, which thereby heats the water. In some contemplated embodiments, the water could be heated to a temperature of between 80° F. to 155° F. (27° C. to 68.3° C.), although specific temperatures can vary depending on the application and the user's needs. The specific size and dimensions of the heating device 106 can vary depending on the rate of water flow through the heating device 106. Preferably, the heating device 106 can heat a water flow of 6 deciliters per second (approximately 300 gallons per hour), which could require, for example, approximately 6 kW of power. However, the specific power requirements can vary depending on the configuration of system 100.

Contemplated heating devices 106 can include, for example, ohmic heating devices, capacitive heating devices, infrared heating devices, or any other commercially suitable water heating devices, or combination(s) thereof. For example, heating device 106 can comprise an ohmic heater that has two or more sets of concentric coils 130, which can be disposed within to heat the water flowing through outlet conduit 107. Alternatively or additionally, the coils 130 can be disposed outside of the outlet conduit 107, and heat the water by conducting heat through outlet conduit 107. The coils 130 of heating device 106 can be composed of any commercially suitable materials including, for example, volfram (tungsten) or other metals, metal composites, or combination(s) thereof.

System 100 can include pressure controllers 110 and 111, and can also have an expansion chamber 138 or other water, pressure controller, which can advantageously regulate a pressure of the water after the water exits chamber 128. Although the expansion chamber 138 is shown branching off from outlet conduit 107, it is contemplated that the expansion chamber 138 could be disposed elsewhere in the system 100 including, for example, along outlet conduit 107 and even downstream of the heating device 106.

The expansion chamber 138 can include a sphere 139 composed of rubber and/or other material(s) such that the sphere 139 can elastically expand and contract without rupture. The sphere 139 can be filled with a fluid such as compressed air, which allows the sphere to return to its initial state as the pressure within the expansion chamber 138 decreases. For example, should the pressure within the expansion chamber 138 increase, this increased pressure can compress the sphere 139, which will thereby reduce the water pressure. The specific size and configuration of the expansion chamber 138 and the sphere 139 will vary depending on the size and dimension of the system 100 and the application.

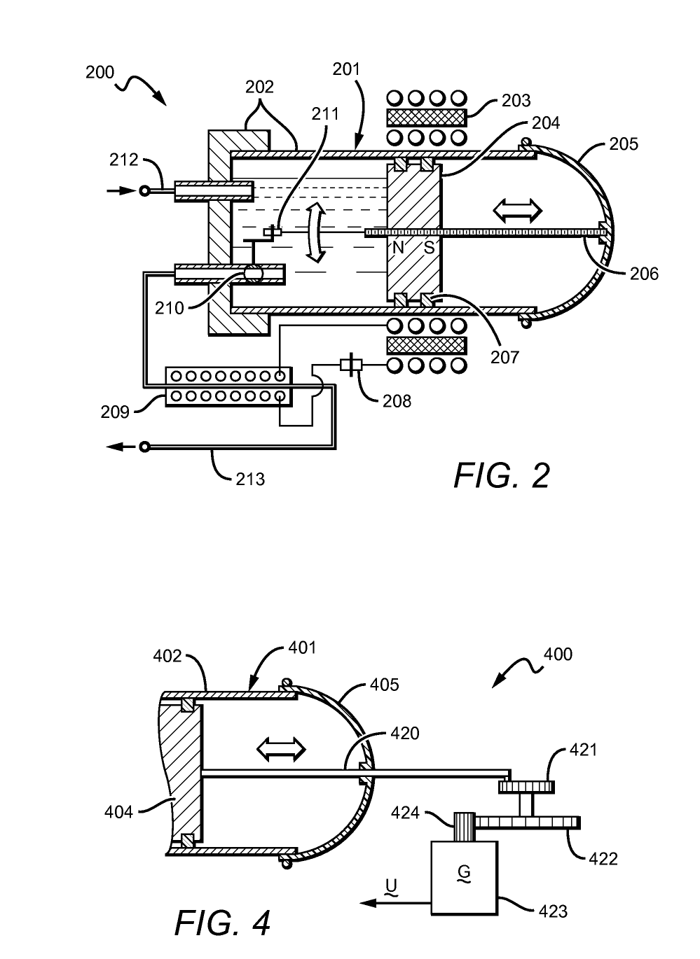

FIG. 2 illustrates an alternative embodiment of a power generation system 200, which includes a water inlet conduit 212 and a water outlet conduit 213 that are each fluidly coupled to a power generator 201. The water outlet conduit 213 can be fluidly coupled to a heating device 209 that can be used to heat water flowing through outlet conduit 213. Any commercially suitable heating device for heating water could be used including, for example, those devices discussed above.

The power generator 201 can include a chamber 202 in which a piston 204 can be disposed. Magnetic coils 203 can be disposed about at least a portion of the chamber 202. The piston 204 preferably has one or more seals 207 that prevent water from passing between the piston 204 and chamber 202. The piston 204 preferably comprises one or more magnets, although magnetized materials, metals, metal composites, and other commercially suitable materials or combination(s) thereof could also be used. As the piston 204 oscillates based upon the water flowing into and out from the power generator 201, the interaction of the piston 204 and coils 203 can thereby generate power.

In some contemplated embodiments, the piston 204 can be coupled to a rod 206 or other member, such that the rod 206 is translated with the piston 204. Thus, as the piston 204 oscillates, a portion of the rod 206 can be pressed against a flexible end 205 of power generator 201, which will cause the flexible end 205 to stretch. Such flexible end 205 could be composed of rubber or other commercially suitable flexible materials or any combination(s) thereof. As the flexible end 205 stretches, a force is applied to the rod 206 in a direction opposite to the pressure force from the water on the piston 204. When the water pressure is less than the force applied on the rod 206 by the flexible end 205, the flexible end 205 will cease to expand and will begin to contract, which causes the rod 206 and piston 204 to move in a second direction that is opposite the first direction.

It is further contemplated that oscillation of the piston 204 can also actuate outlet valve 210, although the valve 210 could alternatively be electronically controlled. In this manner, the valve 210 can be coupled to the piston 204 by a tether 211 such that movement of the piston 204 causes the valve 210 to open and close. Thus, for example, as the piston 204 moves in the first direction (e.g., away from valve 210), the valve 210 is opened. As the valve 210 opens, the water in the power generator 201 begins to exit from the chamber, which reduces the water pressure upon the piston 204, and the force applied to the rod 206 by the flexible end 205 overcomes the water pressure and causes the piston 204 to move in the second direction (e.g., toward the valve 210). Movement of the piston 204 in the second direction causes the valve 210 to close.

Water exiting chamber 202 can flow through heating device 209 where the water can be heated using at least some of the power produced by generator 201. In some contemplated embodiments, the coils 203 can be electronically coupled to the heating device 209 by a circuit including switch 208.

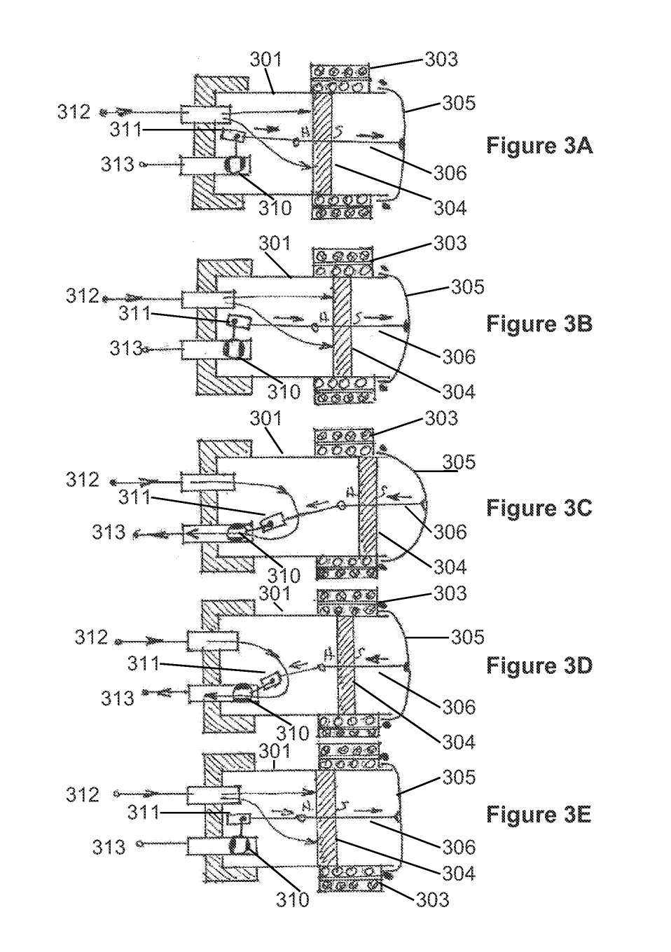

FIGS. 3A-3E illustrate exemplary movement of a piston 304 within chamber 301, and the resulting opening and closing of valve 310. In preferred embodiments, piston 304 has a radius that is at least twice a radius of the inlet conduit 312, and more preferably at least three times, four times, or more of the radius of the inlet conduit 312.

In FIG. 3A, piston 304 is in its initial position and the outlet valve 310 is closed. Water begins to flow into chamber 301 via inlet conduit 312. In FIG. 3B, water continues to flow into chamber 301, and the piston 304 begins to move in a first direction (i.e., away from inlet conduit 312) as a function of water pressure on piston 304. As piston 304 beings to move, a rod 306, which is coupled to piston 304, also begins to move. The movement of rod 306 causes flexible end 305 to stretch.

In FIG. 3C, the piston 304 continues to move in the first direction, which further stretches the flexible end 305 and increases the force applied to rod 306 by flexible end 305. Movement of the piston 304 also moves tether 311, which thereby opens the valve 310. Thus, water can begin to flow out from chamber 301 via outlet conduit 313. As the water exits the chamber 301, the pressure on the piston 304 is reduced, and the pressure applied to the rod 306 by flexible end 305 becomes greater than the pressure applied to piston 304 by the water. As shown in FIG. 3D, this change in pressure cause piston 304 to move in a second direction that is opposite the first direction (i.e. toward valve 310). In FIG. 3E, the piston 304 returns to its initial position, thereby completing one oscillation and causing the valve 310 to close.

Thus, movement of the piston can be controlled using a single mechanical valve 310, which thereby eliminates any need for timer relays or other control circuitry. Oscillation of the piston 304 magnetically interacts with the electromagnetic coils 303 to thereby generate power. With respect to the remaining numerals in each of FIGS. 3A-3E, the same considerations for like components with like numerals of FIG. 2 apply.

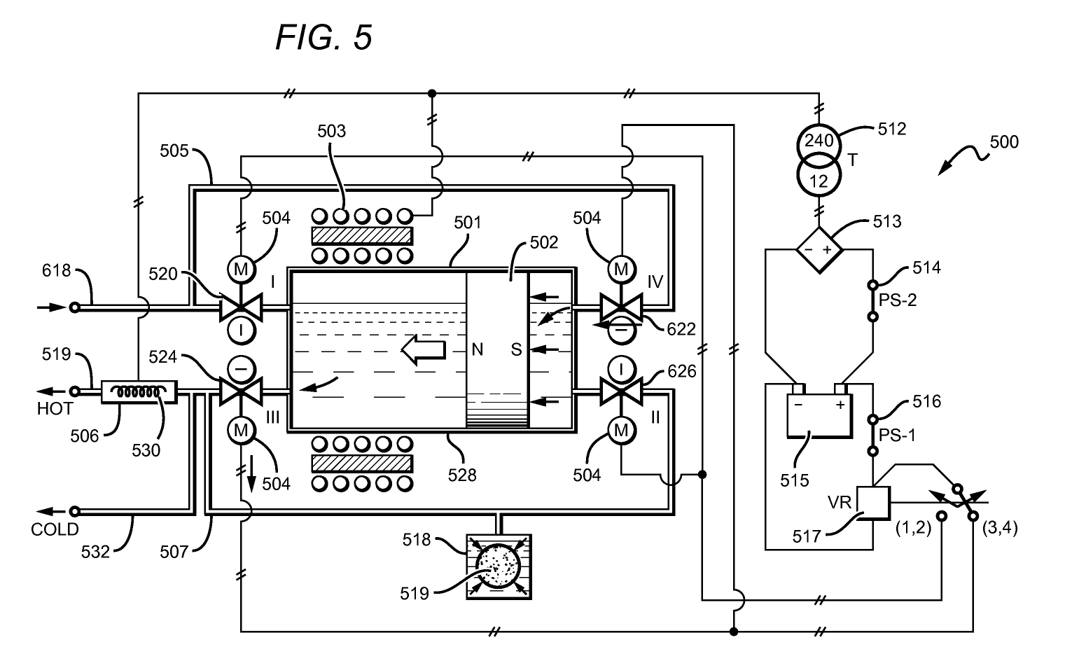

In another embodiment of a power generation system 400 using water pressure shown in FIG. 4, a piston 404 can be disposed within a chamber 401, and be coupled to a crank, rod, or other mechanism 420. The mechanism 420 can in turn be coupled to gear 421, such that the gear rotates as a function of the oscillation of piston 404. It is contemplated that gear 421 can rotate a second gear 422, which rotates a third gear 424 that is coupled to a generator 423. Rotation of the third gear 424 can thereby cause the generator 423 to generate power. Thus, the oscillation of the piston 404 can cause power to be generated without the need for electromagnets. With respect to the remaining numerals in FIG. 4, the same considerations for like components with like numerals of FIG. 2 apply.

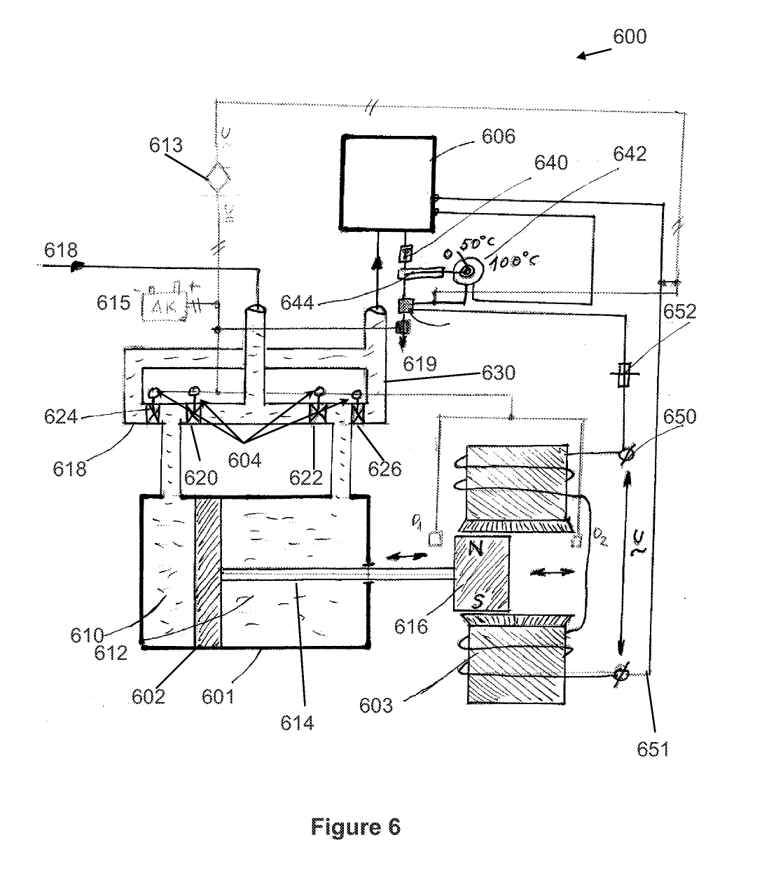

FIG. 5 illustrates another embodiment of a water pressure powered water heater system 500, in which only a portion of the water exiting the chamber 528 flows through water heater 506. The heated water can then flow through outlet conduit 519. The remaining non-heated portion of the water can flow through second outlet conduit 532 where it can be used for purposes not requiring heated water. In such embodiments, the generator 501 can thereby generate energy using water from a main water line, prior to the water being split into hot and cold lines. With respect to the remaining numerals in FIG. 5, the same considerations for like components with like numerals of FIG. 1 apply.

In FIG. 6, another embodiment of a system 600 is shown for generating power using water pressure. A water feed flows through inlet conduit 618 and into a chamber 601 through one of valves 620 and 622. The chamber has a variable-size first portion 610 and a variable-size second portion 612, which are separated by piston head 602. Thus, as the piston head 602 moves within the chamber 601, the relative volumes of the first portion 610 and the second portion 612 will change.

As water flows into one of the first and second portions 610 and 612 of the chamber 601, the water pressure can cause movement of the piston head 602 in a first direction. Water in the opposite chamber can exit from the chamber by way of either valve 624 or valve 626. In some contemplated embodiments, an inlet valve and exit valve can be opened simultaneously, although it is alternatively contemplated that the inlet and exit valves could be opened sequentially. Thus, for example, valve 620 and valve 626 can open simultaneously or sequentially, which when both valves 620 and 626 are opened allows water to flow into the first portion 610 of the chamber 601, and out from the second portion 612. In this manner, as the water enters and exits the respective portions 610 and 612 of the chamber 601, the increased pressure in the first portion 610 and decreased pressure in the second portion 612 will cause the piston head 602 to move toward the second portion 612. Valves 620 and 626 can then close, and valves 622 and 624 can open, which causes water to flow into the second portion 612 and out from the first portion 610. This results in a decreased pressure on the first portion side of the piston head 602, and an increased pressure on the second portion side of the piston head 602, which thereby causes movement of the piston head toward the first portion 610.

The piston head 602 can be coupled to a piston arm 614, which can be coupled to a magnetic piece 616. Thus, movement of the piston head 602 within chamber 601 can cause movement of the piston arm 614 and magnetic piece 616. In preferred embodiments, the magnetic piece 616 translates back and forth among magnetic coils 603, such that the interaction between the coils 603 and magnetic piece 616 as the magnetic piece 616 translates produces power. This power can be transmitted from coil end 650 along circuit 651 to water heater 606, battery 615, valve actuators 604, or other electronic components or devices. The circuit 651 can include a switch 652. It is contemplated that system 600 can create 0.5 KW-1.0 KW of power, or more, and can thereby power a variety of electronic devices or transmit the power to the energy grid.

From the chamber 601, water can flow through outlet conduit 630 via valve 624 or valve 626. In some contemplated embodiments, at least some of the water can then be fed into a water heater 606 where it is heated. Contemplated water heaters include, for example, ohmic heating devices, capacitive heating devices, infrared heating devices, or any other commercially suitable water heating devices, or combination(s) thereof. In alternative embodiments, however, it is contemplated that the system 600 can operated without a water heater 606.

Water heater 606 can be controlled by thermostat 642, which can restrict the energy to the water heater 606 to shut off the water heater 606, or reduce the heat outputted by the water heater 606. A temperature of the water leaving the water heater 606 can be monitored by a temperature switch 644 or other sensor, which can transmit a signal to the thermostat 642 or other component to restrict energy to the water heater 606, or can do so directly. The heated water can then exit the water heater past check valve 640 and through conduit 619.

One of the advantages of the system 600 over the prior art is that the piston head 602 is at least two times, more preferably, at least three times, and most preferably, at least four times a radius of the inlet conduit 618. Typically, prior art devices utilized a turbine to generate power from a municipal water line. However, only a minimal amount of energy was extracted (e.g., 90 W from water at a pressure of 35-psi and a flow-rate of 37.9 lpm). In the present embodiment, system 600 can extract at least 0.5 KW of power, which is a substantial increase. This is likely due to the four-fold increase in the surface area of the piston head when the radius is doubled, and the nine-fold increase in the surface area when the radius is tripled. With respect to the remaining numerals in FIG. 6, the same considerations for like components with like numerals of FIG. 1 apply.

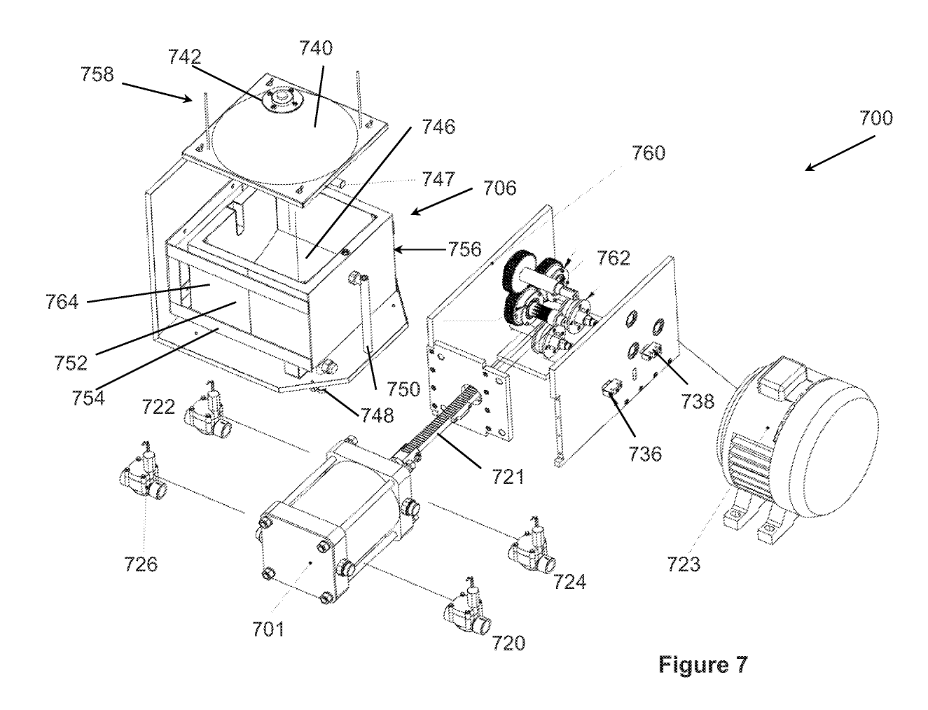

FIG. 7 illustrates another embodiment of a system 700 for generating power using water pressure having a chamber 701 into which water can flow. Valves 720 and 722, and valves 724 and 726, control the flow of water into and out from the chamber 701, respectively. Water flowing into and out from the chamber 701 can cause oscillation of a piston (not shown) within the chamber 701. This in turn oscillates piston arm 721, which is attached to the piston. As the piston arm translates back and forth, gears 762 within gear box 760 are rotated, which thereby rotates an axle of generator 723 to generate power. At least a portion of the power can be used to power water heater 706 and/or other electrical devices.

Water heater 706 can include an outer housing 752 that preferably encloses an inner chamber 756. The inner chamber 756 and outer housing 752 can be composed of any commercially-suitable material(s) including, for example, stainless steel and other metals, metal composites, and any combination thereof. Water can enter the water heater 706 via inlet conduit 748, which is fluidly coupled to valves 724 and 726. Preferably, the water flows into a water jacket (not shown) formed between the outer housing 752 and the inner chamber 756. In this limner, the water filling the water jacket can be used to cool the inner chamber 756 while heating the water within the water jacket. In addition, the water in the water jacket can flow about a reflector 740, which can thereby cool the reflector 740 and the top piece 758 of the inner chamber 756.

The inner chamber 756 can comprise outer walls 764 and a top piece 758 that preferably includes a reflector 740, one or more infrared (IR) bulbs (not shown), and a bulb fixture 742. In preferred embodiments, the bulb fixture 742 can be removably coupled to reflector 740, which advantageously allows the one or more bulbs to be quickly replaced. Contemplated water heaters 706 include between one to three bulbs, although a greater number of bulbs could also be used. While an IR water heater 706 is shown, any commercially suitable water heater could be used including, for example, those discussed above.

Contemplated bulbs preferably produce IR radiation having a predominant wavelength of between 2700-3300 nm. All suitable IR light sources are contemplated, including especially tubular bulbs, such as the Sylvania® 59934 special stranded LDS Base 3,000 K clear infrared double ended quartz halogen (1200T3Q/IR/CL/HT 144V). Another suitable choice is a Philips® 312678 1,000 watt 235 volt T3 Z Base 2,450 K clear reflector industrial infrared quartz halogen (13713Z/98 1000 W 235V). Tubular bulbs are preferred because when placed at the focus of a tubular parabolic mirror, their heat energy tends to be distributed along the water containing conduit, rather than at a single point.

The inner chamber 756 can also include reflective walls, and a reflective, concave, and preferably nominally parabolic, bottom piece 746. As used herein, the term “concave reflector” means a reflector having a parabolic or other generally-concave shape with the concave portion facing an IR light source. A conduit 747 preferably passes through the inner chamber 756 to allow water within the conduit 747 to be heated by the IR radiation from the bulbs. It is especially preferred that the conduit 747 be nominally positioned at the focus of the concave bottom piece 746. In this manner, IR radiation emitted from the one or more bulbs can be directed downwardly by reflector 740, and the radiation can then be focused upon the conduit 747 by the reflective bottom piece 746. In preferred embodiments, the radiation emitted from the one or more bulbs can be collimated by reflector 740. The collimated radiation can then be directed to a focus of the concave bottom piece 746, which thereby heats the water in the conduit 747. The heated water can then exit the inner chamber 756 via outlet conduit 750. This arrangement advantageously allows the water to be heated without directly contacting the heating element with the water. In this manner, short circuits and other issues can be prevented.

As used herein, the term “nominally” means a quantity, relationship, or location is within 20% of a stated quantity, relationship, or location. For example, a light source is disposed nominally at a focus of reflector 740 if the light source is disposed within 20% of the focus, as defined by the distance between the focus of the reflector 740 and a center point of the reflector 740. So, if the distance between the focus and center point of the reflector 740 is 1 m, than the light source is disposed nominally at a focus of the reflector 740 if the light source is disposed within plus or minus 0.2 m of the focus point in any direction.

It is contemplated that a temperature of the water at the outlet conduit 750 can be between 25° C. to 160° C., and more preferably between 70° C. to 130° C. in this manner, a temperature gradient between the feed water at the inlet conduit 748 and the heated water at the outlet conduit 750 can be at least 40° C., more preferably at least 60° C., and most preferably at least 80° C.

A set of brackets 754 can be used to maintain the position of the inner chamber 756 with respect to the outer housing 752. Additionally or alternatively, any commercially suitable fasteners could be used to maintain the position of the inner chamber 756.

System 700 can include micro-switches 736 and 738, which assist in controlling the actuation of valves 720, 722, 724, and 726. With respect to the remaining numerals in FIG. 7, the same considerations for like components with like numerals of FIG. 4 apply.

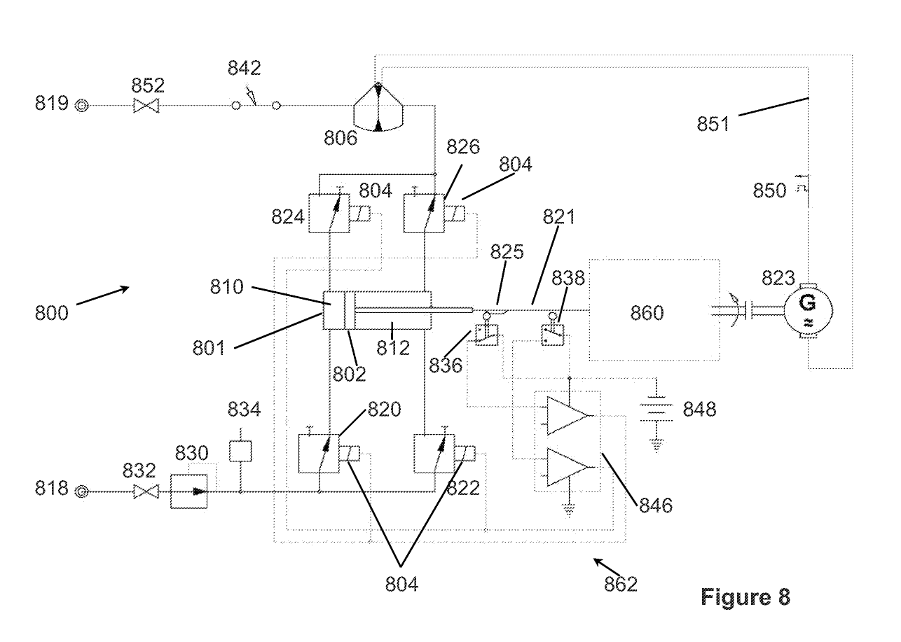

FIG. 8 illustrates a functional schematic of an embodiment of a system 800 for generating power using water pressure. Water flows into system via inlet conduit 818 past check valve 830, and into chamber 801 via one of valves 820 and 822. The flow of water into and out from the chamber 801 causes movement of the piston head 802 within the chamber 801. As the piston head 802 oscillates, the piston arm 821 also oscillates.

In preferred embodiments, the piston arm 821 can advantageously include an extended portion 825 that interacts with first and second micro-switches 836 and 838. In this manner, as the extended portion 825 is translated, the extended portion 825 can depress each of micro-switches 836 and 838, which can thereby signal one or more of the valve actuators 804 to open one or more of valves 820, 822, 824, and 826. Thus, for example, when the extended portion 825 depressed micro-switch 836, a signal can be sent to the valve actuators 804 such that valves 822 and 824 can be opened, and valves 820 and 826 can be closed. It is contemplated that the signals from the micro-switches 836 and 838 can be sent to a controller 846, which can then send command signals as necessary to the valve actuators 804. A circuit 862 can electronically couple the micro-switches 836 and 838, controller 846, valve actuators 804, and an accumulator 848.

Movement of the piston arm 821 can be leveraged by gear box 860 to generate power through the rotation of gears within the gear box 860 that rotates an axle of generator 823. For a low speed shaft, a speed of 60 rotations per minute is contemplated, although the number of rotations can vary depending upon the gear box 860 and generator 823 selected. Circuit 851 allows power from the generator 823 to be transmitted to the water heater 806. The circuit 851 can include one or more fuses 850 to protect against excess current within the circuit 851.

The system 800 can include valves 832 and 852 to control the water flow entering and existing system 800, respectively. System 800 can also include a push switch 834 that monitors at least one of a temperature, pressure or flow of the inlet water flow in inlet conduit 818. With respect to the remaining numerals in FIG. 8, the same considerations for like components with like numerals of FIG. 6 apply.

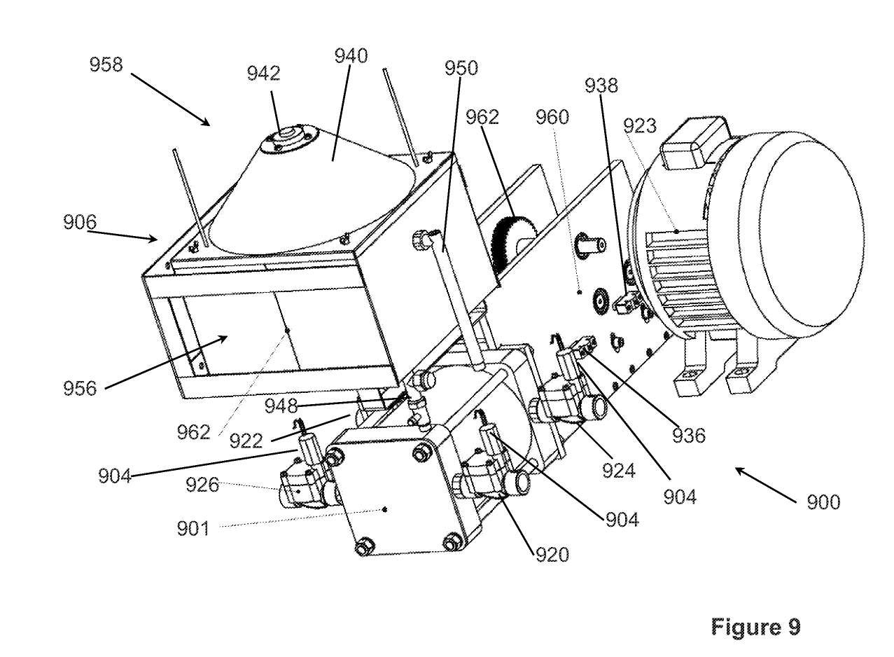

FIG. 9 illustrates another embodiment of a water pressure powered water heater system 900 having a chamber 901 into which water can flow and thereby cause movement of a piston head (not shown). The movement of the piston causes movement of gears 962 within gear box 960, which thereby produces power in generator 923.

From the chamber 901, water can flow into a water heater 906, where the water can be heated using at least some of the power generated by generator 923. With respect to the remaining numerals in FIG. 9, the same considerations for like components with like numerals of FIG. 7 apply.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

### Example

A test of an embodiment of a system for generating power using water pressure was conducted at the University of Kragujevac in Serbia. Water flowed into a chamber at a pressure of 4 bar (approx. 58 psi). As water flowed into and out from the chamber, movement of the piston resulted in 1000 rotations per minute of an alternator. This translated into 20 strokes per minute of the generator, which was sufficient to generate more than 1 KW of energy. This energy was then used to heat water in a water heater to a temperature of approximately 40° C. The flow rate of water through the water heater was measured at 18 liters per minute.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system that uses water pressure to impart heat to a flow of water, comprising:
a power generator having an inlet and an outlet, and configured to generate power at least in part by utilizing the pressure in the water flowing through the inlet;
a first valve configured to control an outlet flow of water through the outlet; and
a heating device configured to utilize the power to heat the outlet flow of water.

2. The system of claim 1, further comprising a second valve fluidly coupled to the inlet, and configured to control an inlet flow of water through the inlet.

3. The system of claim 1, wherein the heating device is disposed downstream of the second valve.

4. The system of claim 1, wherein the heating device comprises an infrared water heater.

5. The system of claim 2, further comprising a third valve fluidly coupled to the inlet and the power generator, and a fourth valve fluidly coupled to the outlet and the power generator.

6. The system of claim 5, wherein the first and third valves regulate a flow of water into the power generator, and wherein the second and fourth valves regulate a flow of water into the power generator.

7. The system of claim 1, wherein the power generator comprises a piston.

8. The system of claim 1, wherein the power generator comprises a turbine.

9. The system of claim 1, wherein the power generator comprises a solenoid.

10. The system of claim 1, wherein the power generator is capable of generating at least 1.0 kW of power.

11. The system of claim 1, further comprising a pressure regulator fluidly coupled to the outlet.

12. A system that generates electrical power from a municipal water line, comprising:
a chamber configured to receive water from the water line;
a piston reciprocating within the chamber as a function of a pressure of the water; and
an electrical generator configured to produce at least 0.5 KW of electricity from movement of the piston.

13. The system of claim 12, further comprising an inlet conduit fluidly coupled to the chamber, and wherein a radius of the piston is at least two times a radius of the inlet conduit.

14. The system of claim 12, further comprising an inlet conduit fluidly coupled to the chamber, and wherein a radius of the piston is at least three times a radius of the inlet conduit.

15. The system of claim 12, further comprising an inlet conduit fluidly coupled to the chamber, and wherein a radius of the piston is at least four times a radius of the inlet conduit.

16. The system of claim 12, wherein the electrical generator is capable of generating of at least 1.0 KW of power.

17. The system of claim 12, wherein an outlet pressure of the outlet flow of water is at least 90% of an inlet pressure of the inlet flow of water.

18. The system of claim 12, further comprising an infrared water heater that receives at least some of the electricity produced by the generator, and wherein the water heater is configured to heat at least a portion of an outlet flow of water from the chamber.
